(19) United States
(12) Patent Application Publication
(10) Pub. No.: US 2002/0004411 A1
(43) Pub. Date: Jan. 10, 2002

(54) Hybrid radio apparatus for digital communications

(76) Inventors: Stephen B. Heppe, Purcellville, VA (US); K. Prasad Nair, Bethesda, MD (US); Steven Friedman, Silver Spring, MD (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,551

(22) Filed: May 4, 2001

Related U.S. Application Data
(60) Provisional application No. 60/202,117, filed on May 5, 2000.

(51) Int. Cl. H04M 1/00

(52) U.S. Cl. 455/552; 455/550; 455/525

(57) ABSTRACT

A hybrid radio apparatus for a mobile radio station capable of operating in at least two different radio networks, employing at least two different protocols, said hybrid radio apparatus comprising a hybridization module for at least one of the networks (network A) and the normal radio equipment for at least one other of the networks (network B), said hybridization module comprising the electronics and software necessary to emulate some or all of the protocols of network A, and communicating at an appropriate peer level with the network B protocols resident in the hybrid radio apparatus. The hybrid radio apparatus may be installed in several configurations of ancillary equipment, offering the potential to communicate via one network or more than one network, as well as the potential to provide a human interface and management unit for one network or more than one network. This flexibility offers operational and logistical advantages, and potentially other advantages, to users who may operate in regions covered by different networks, or users who are transitioning their operations from one network to another.

### REFERENCE TO RELATED APPLICATION

The present application claims the benefit of U.S. Provisional Application No. 60/202,117, filed May 5, 2001, whose disclosure is hereby incorporated by reference in its entirety into the present disclosure.

### FIELD OF THE INVENTION

The present invention is directed to the transmission and reception of digital information by mobile users through multiple radio communications systems.

### BACKGROUND OF THE INVENTION

Commercial aircraft commonly transmit and receive air/ground digital information via radio equipment operating in the Very High Frequency (VHF) portion of the radio spectrum, on 25 kHz channels, using a data protocol known as the Aircraft Communications Addressing and Reporting System (ACARS). The ACARS air/ground environment is described in ARINC Specification 618. The capabilities of onboard equipment are defined in ARINC Characteristics 597, 724 and 724B. Other standards may also apply. There are several variations of the ACARS protocol in use today, including extensions to satellite relay media and High Frequency (HF) radio. An enhancement known as VHF Digital Link Mode 2 (VDL/2) has been introduced. Communications services using these protocols are provided by commercial enterprises on a for-fee basis, using networks of fixed stations which support compatible protocols and hardware. The airborne equipment, ground station equipment and extended ground network all cooperate to support the end-to-end transmission and reception of digital information between an aeronautical mobile station and a ground-based end-system. It is the responsibility of the service provider to manage the air/ground exchange of data and provide routing and protocol conversions as needed to interface with the intended users' ground-based end-systems. Routing and format translation functions are described in ARINC Specification 620. A characteristic of the air/ground protocol is that mobile stations (e.g., aircraft) are designed to search for and detect special transmissions from compatible ground stations before initiating transmission, as a means to determine when they are within coverage, and which frequency channel should be used.

A disadvantage of ACARS and VDL/2 is the inability to deliver time-critical information in a reliable manner. An alternative protocol, known as VHF Digital Link Mode 4 (VDL/4), can reliably handle time-critical information but is not widely implemented in the field. This protocol uses a different modulation technique and a different media access protocol than either ACARS or VDL/2. VDL/4 users can exchange information among themselves without requiring the presence or active participation of fixed base stations or ground stations. However, fixed base stations or ground stations may be present in order to support internetworking with other users and networks (these networks may provide a communications path to a selected groundbased end system). All VDL/4 stations, including fixed base stations, transmit special bursts of information which can be detected by other VDL/4 users within range. These bursts support, among other functions, a means to determine when a mobile user is within range of a compatible ground station.

The ACARS, VDL/2 and VDL/4 protocols and networks are not compatible with one another. As a consequence, the transmission and reception of digital information via these protocols may be expected to occur with different sets of user equipment operating in non-overlapping portions of the frequency spectrum (i.e., different frequency channels).

Certain existing users may wish to transition from ACARS or VDL/2 networks to emerging VDL/4 networks. Unfortunately, due to the current limited deployment of VDL/4 ground assets (e.g., fixed base stations and networks), these users may be forced to carry equipment for both systems (e.g., ACARS and VDL/4), and participate in both systems, in order to assure the availability of services over a specified route structure or operating region. This can lead to increased crew workload, increased complexity of operational procedures, and increased recurring and nonrecurring costs as a consequence of the need to operate in two networks over the course of a single flight or series of flights.

In most prior systems for exchanging digital information, a user equipped to operate within a given system was unable to operate in other systems. This is illustrated in FIG. 1 where a user equipped for system A can operate in region of coverage for Network A 11, while a user equipped for system B can operate in the region of coverage for Network B 12. A user wishing to operate in both networks (for example, to support an extended route structure spanning two networks 14), would traditionally require equipage for both system A and system B. Not shown in this figure, are the network(s) of ground stations and internetworking facilities designed to support operations in the defined service areas, and route information to/from desired end-systems. These internetworking facilities could allow a mobile user to communicate with a single ground-based end-system (e.g., a user's control facility) via either of the networks illustrated.

FIG. 2 illustrates typical sets of hardware elements and associated processing functions within a mobile station. The Human Interface and Management Unit (HIMU) comprises input and output functionality for the exchange of digital information as well as control functionality for the mobile radio. The radio comprises the modulation and demodulation functions (among others). These hardware elements may or may not be located within a single chassis. As an example, the ACARS functionality on an aircraft may be implemented with a VHF transceiver, an ACARS Management Unit (MU), and a separate control/display unit (either dedicated or multi-purpose). Ancillary equipment may include a digital flight data acquisition unit or cockpit printer. The detailed allocation of functions to hardware elements depends on the design of the systems involved, and may vary considerably. However, for the traditional implementation illustrated in this figure, a user requires two separate “strings” of hardware and a switching device (or method) in order to operate in two separate networks. For example, HIMU A 21 and radio A 22 for communication over Network A may represent one string of equipment while HIMU B 23 and radio B 24 for communication over Network B may represent a second string of equipment. Each unit may be connected to a source of power and have interfaces to other equipment, and the radio(s) are typically connected to an antenna for the radiation and collection of radio-frequency energy. All elements for communication over Network A and Network B may be combined in a single device as shown by HIMU A 25, radio A 26, HIMU B 27 and radio B 28, but the fundamental character of the separate equipment strings is typically preserved. A single equipment string may also be flexible or reconfigurable in order to support communications over two or more networks. In this case either the human user may select a preferred mode of operation, or the equipment itself may automatically select a preferred mode of operation based on software rules and RF signals detected via the radio equipment. When a single reconfigurable equipment string is used, two equipment strings may be considered to exist in a “virtual state” with only one or the other having operational effectiveness at a given instant of time. Examples of the traditional implementation are disclosed in Phillips, et. al. (U.S. Pat. No. 5,020,092), wherein a dual bandwidth cellular telephone is disclosed, and Pirch (U.S. Pat. No. 5,020,093) relating to a similar system. Kivari, et. al. (U.S. Pat. No. 5,396,653) disclose a cellular telephone signaling circuit operable with different cellular telephone systems, wherein the switching function is DSP or microprocessor controlled. Freeburg (U.S. Pat. No. 5,327,572) describes a networked satellite and terrestrial cellular radiotelephone system. Grube, et. al. (U.S. Pat. No. 5,371,898) describes a method for a communications unit to operate in either a trunking or a cellular communications system using full equipment strings and automatic switching. Tsuji, et. al. (U.S. Pat. 5,590,174) describes an apparatus and method for mobile communications networking, using dual transceivers and a switching device, which ensures that a user who is out of a service area can receive an incoming call from another service area. Byrne, et. al. (U.S. Pat. No. 5,659,598) describes a dual mode subscriber terminal and a handover procedure of the dual mode subscriber terminal in a mobile telecommunications network, which also uses dual equipment strings, standard communications protocols and a selection capability.

The existence of multiple equipment strings, whether actual or virtual, may affect overall mobile station cost, weight, power and thermal management accommodations, as well as the user's perceived cost associated with logistics and training, the complexity of operational procedures, etc. There may also exist a need to retain certain features of one system even while using the communications capability of another system. This might include, for example, the human interface located in the cockpit of an aircraft and also the analog voice capability provided by at least one (but not all) of the systems involved. If the human interface and radio equipment are located in separate chassis, the reuse of the human interface and interactive control protocols for additional networks may lead to reduced equipment costs and reduced training costs in certain situations.

### SUMMARY OF THE INVENTION

This invention is a hybrid radio apparatus for transmitting and receiving digital information via multiple incompatible systems A, B, C, . . . . It comprises a hybridization module which, in conjunction with other equipment, allows the reuse of certain equipment and the partial or complete emulation of the protocols associated with at least one of the multiple incompatible systems A, B, C, . . . . This partial or complete emulation is not normally achieved within the confines of a single station of any of the incompatible systems A, B, C, . . . . The hybrid radio apparatus offers the following benefits:

a) reuse of the human interface equipment for a single system (simplifies user workload and operational procedures; reduces procurement and ongoing logistics costs);

b) simultaneous reception on two or more incompatible networks (enhances quality of service);

c) automatic mode switching based on preset or user-specified cost or procedural considerations;

d) capability to exchange digital information with other users whenever connectivity with appropriate stations, supporting any of the incompatible protocols supported by the apparatus, is available (enhances quality of service).

### BRIEF DESCRIPTION OF DRAWINGS

FIG. 1 illustrates a conceptual view of the subject operational environment. Two of possibly N incompatible networks are illustrated.

FIG. 2 illustrates a conceptual view of the mobile user's equipment to operate in Network A alone, Network B alone, or both Network A and Network B using traditional means.

FIG. 3 illustrates a conceptual view of the hybrid radio apparatus and associated equipment, which allows the mobile user to operate in either Network A or Network B. This figure also tabulates five installation options for the hybrid radio apparatus.

FIG. 4 illustrates a detailed view of the hybrid radio apparatus and associated equipment for a preferred embodiment, wherein Network A is ACARS or VDL/2 and Network B is VDL/4.

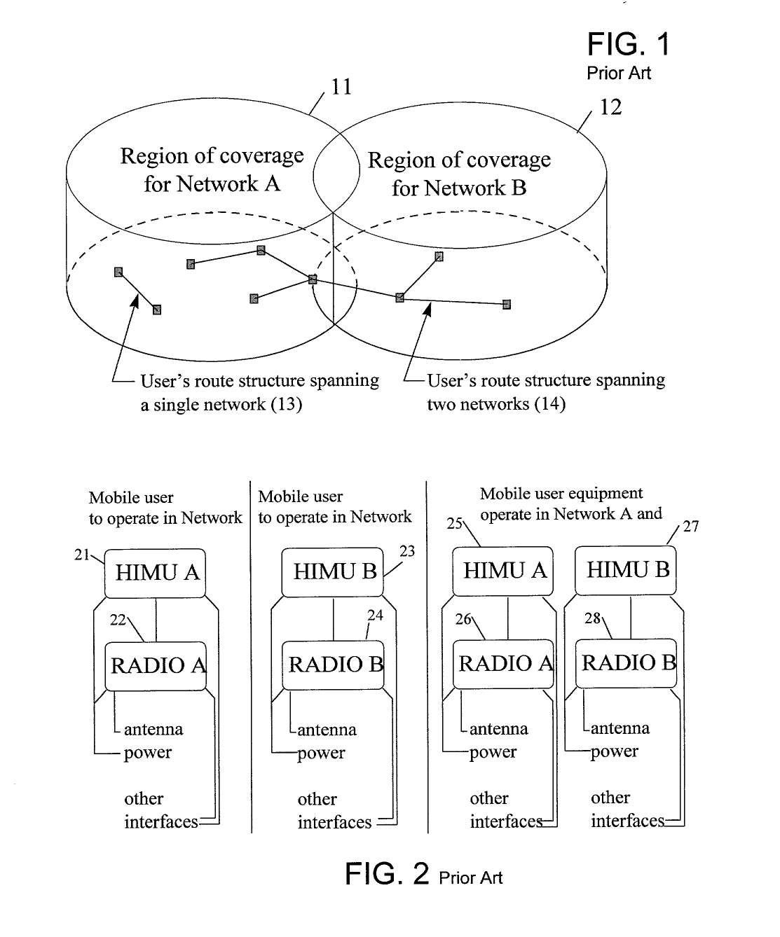

### DETAILED DESCRIPTION OF THE INVENTION

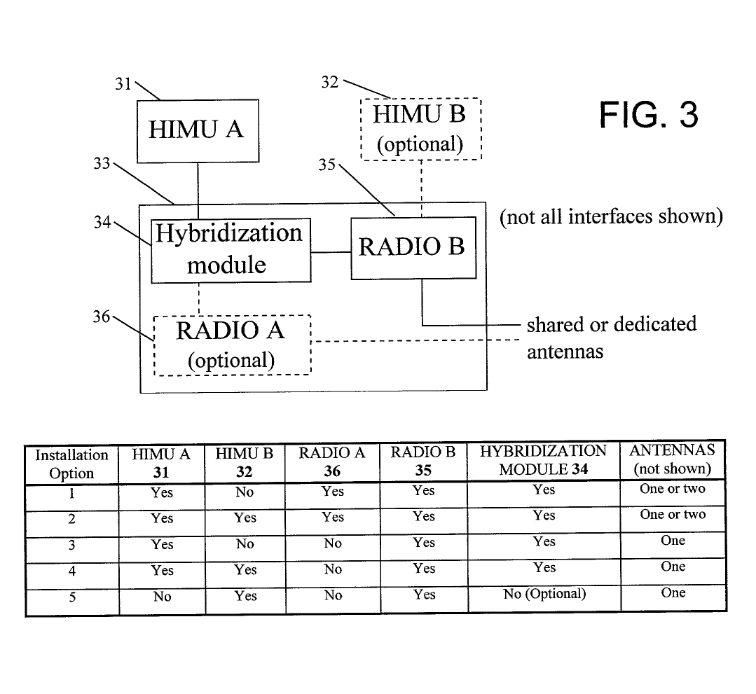

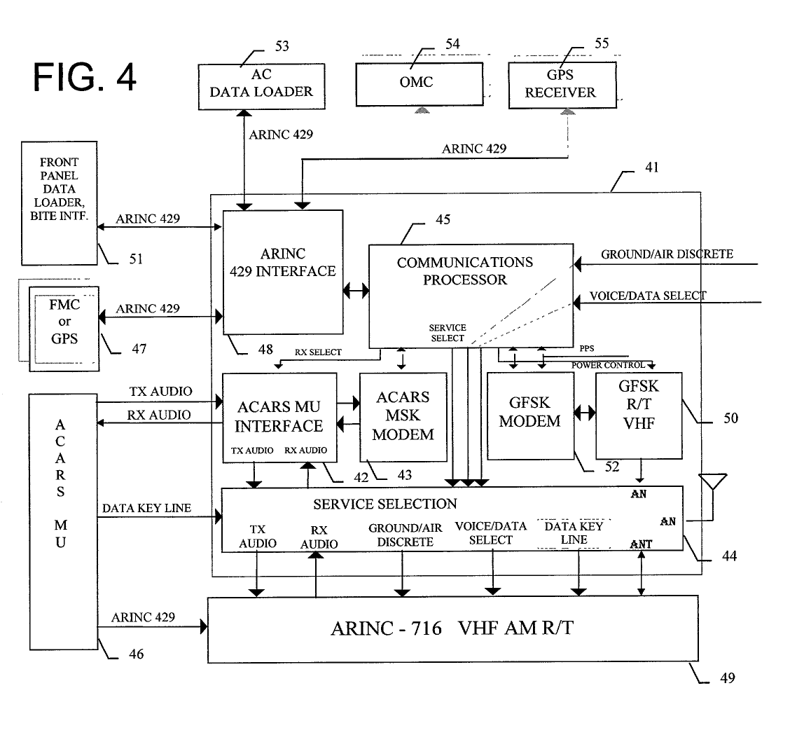

Preferred embodiments of the present invention will be set forth with reference to FIGS. 3 and 4.

FIG. 3 illustrates the generic embodiment of the hybrid radio apparatus 33, which comprises a hybridization module 34 for System A, a radio B 35 for System B, and a radio A 36 for System A (optional). The hybridization module 34 provides a partial or complete emulation of the airborne radio equipment for System A as well as a partial or complete emulation of the ground-based hardware and software elements for System A. This differs from the traditional means of integrating the capability to use multiple networks or systems into a mobile platform. If radio A is present in the user's equipment, both radio A and radio B may be active simultaneously in their respective networks. The emulation allows HIMU A 31 to operate as if it was participating in Network A, whether information is conveyed via Radio A 36 operating in Network A or Radio B 35 operating in Network B. When the mobile user is in the operating region of Network A, and not in the operating region of Network B, for example, the hybridization module is relatively passive and merely routes signals between the HIMU A 31 and the radio A 36 of System A. When the mobile user is in the operating region of Network B, the hybridization module emulates, as required, the mobile radio equipment and ground-based protocols for System A. This allows HIMU A 31 to operate as if it were still active in Network A, allowing the re-use of HIMU A. However, the uplink and downlink data is actually handled via radio B 35 operating in Network B, with appropriate internetworking by the service provider to reach an intended intermediate network or end-system on the ground. When the mobile user is in a region of overlapping coverage between Network A and Network B, the hybrid radio apparatus and its hybridization module may operate in either of the modes described herein, with the choice dependent on pre-set programming or mobile user commands. Typically but not always, this choice may be based on cost of service or quality of service available via the two networks. The choice may be automatic or manual (i.e., by the human user). If automatic, the human user is not necessarily aware of which network has been selected, although an indicator may be provided.

If both radio A 36 and radio B 35 are present, the hybrid radio apparatus may simultaneously monitor the radio activity detected by both (note: in some implementations the receive capability may be disabled during transmissions by the mobile station. However, mobile station transmissions are typically of short duration and low duty cycle, and not all implementations are so limited). This monitoring activity allows the hybrid radio apparatus (or the human user) to make a decision on which network is most appropriate for any given communication event. The decision may be based on which networks and services are available at a given instant of time, and may also be based on geographic location, cost, quality of service and other parameters.

If System A and System B support identical applications, only a single HIMU is required. In FIG. 3, this is illustrated as the HIMU A 31 for System A. The mobile user can operate in either network via this unit. If System A and System B support dissimilar applications, a dedicated HIMU may be required for each system (as illustrated by HIMU A 31 and HIMU B 32). The decision to install and operate a dedicated HIMU for each system depends on the applications and needs of the user.

The radio A 36 for System A is shown as optional in FIG. 3. If deleted, the mobile user can still operate in Network B using the HIMU A 31 of System A (or the HIMU B 32 of System B if this HIMU is installed). The radio A 36 for System A may be deleted to conserve weight, power and maintenance and logistics expenses if, for example, Network B expands to cover the area of operations of the mobile user.

The hybrid radio apparatus comprises the ability to support the five distinct installation options identified in FIG. 3. In installation option 1, the user relies exclusively on the HIMU A 31 for System A but is served by either Network A or Network B depending on pre-set or user-commanded selection criteria. In this fashion, a transparent user interface is provided to both networks. In installation option 2, a HIMU B 32 for System B is available to support applications not available via System A. Installation options 3 and 4 are similar to installation options 1 and 2, but the radio A 36 for System A has been deleted and all communications flow via Network B. In installation option 5, only functionality associated with System B is installed. The hybridization module is not required in this case, but may be retained to avoid equipment replacement expenses if, for example, the user is transitioning operations from Network A to Network B. By offering these distinct installation options, the hybrid radio apparatus can satisfy the needs of a broad range of users, allow the re-use of some existing equipment, and support cost-effective transition from System A to System B as regions of coverage for Network A and Network B vary over time.

FIG. 4 illustrates elements of a preferred embodiment for the case where Network A is ACARS and Network B is VDL/4. The hybridization module 41 comprises the ACARS MU interface 42, the ACARS MSK modem 43, the service selection module 44 and elements of the communications processor 45. The control/display device(s) providing the human interface are not shown, but these could be interconnected to the ACARS MU 46, the FMC 47, or the Communications Processor 45 via, for example, the ARINC 429 interface 48. The radio equipment comprises the ARINC 716 R/T 49 and the GFSK R/T 50 for this embodiment, which provides for services via ACARS and VDL/4 networks. This embodiment shares the human interface for the ACARS system and reuses the ACARS radio equipment in geographic areas where VDL/4 services are not available. The elements of FIG. 4 are described below.

Accommodation for a front panel data loader/built-in test equipment (BITE) interface 51 provides a method of updating the avionics software without requiring removal of the avionics from the aircraft. The communications processor 45 software, ACARS MSK modem 43 software, and GFSK MODEM 52 software can be updated via this interface. This interface is described in ARINC Specification 615-3 “Airborne Computer High Speed Data Loader.” This interface also accommodates portable diagnostic equipment that can command the BITE, and record and display the results of the BITE.

Accommodation for a Flight Management Computer (FMC) 47 allows for installations where the aircraft FMC provides position and velocity data (a Global Positioning System (GPS) receiver could also be used). This interface is an ARINC 429 listen only interface. Interfaces to at least two FMCs or GPS receivers would typically be provided. The communications processor software would monitor all the FMCs (for example) and select the active one.

The ACARS MU interface 42 provides a fan-out of the TX audio signal from the ACARS MU 46 and provides this signal to the ARINC 716 VHF AM radio 49 and to the ACARS MSK MODEM 43. The signal “RX Select” from the Communication Processor 45 controls the source of RX audio provided to the ACARS MU 46. RX audio is provided from the ACARS MSK modem 43 when the ACARS MU 46 is communicating via the VDL/4 network and from the ARINC 716 VHF AM radio 49 when the ACARS MU 46 is communicating via an ACARS network.

When no transmissions are being made, the communications processor 45 receives incoming data via ACARS (on the ARINC 716 radio 49) and also the VDL/4 network (on the GFSK R/T 50 and GFSK modem 52). This allows the communications processor to determine which networks are available to the mobile station and which services are available on each network. The communications processor 45 can then determine which network should be used for any given user transmission. Incoming data from both networks may be routed to appropriate end systems onboard the aircraft.

The data key line from the ACARS MU 46 controls the ARINC 716 transmitter 49 in traditional ACARS-only installations, but is intercepted by the service selection module 44 of the hybrid radio apparatus 41. When the 716 radio is not being used for data communications with an ACARS network, this signal is prevented from being asserted to the ARINC 716 transmitter 49, thus preventing the keying of the transmitter. As part of the network control protocol for the ACARS network, the ACARS MU 46 may attempt to initiate network entry, keep-alive and handoff transactions as a result of uplink messages it receives from ACARS ground stations via the ARINC 716 radio 49. These can be intercepted by the communications processor 45 and the appropriate ground station responses emulated via the ACARS MU interface 42, without ever allowing transmission by the ARINC 716 radio 49. In this way, the ACARS MU 46 acts as if it is active in an ACARS network even when it is not.

The ACARS MSK modem 43 is active when the ACARS MU 46 is communicating via the VDL/4 network; it provides the interface between the communications processor 45 and the ACARS MU 46. The demodulation of receive audio from and modulation of transmit audio to the ARINC 716 VHF AM radio 49 is not required since communications in this case is via the VDL/4 network. The ACARS MSK modem 43 is used solely for interface between the communications processor 45 and the ACARS MU 46. This MSK modem function is simple to implement since a low distortion high signal-to-noise ratio signal is assured. If the ACARS MU 46 is replaced with a Communications Management Unit (CMU), and the ARINC 716 radio 49 is replaced with an upgraded version such that the interface between these two devices is digital information as opposed to a modulated MSK signal, the ACARS MSK modem 43 can be deleted and the nomenclature for the TX AUDIO and RX AUDIO lines would be modified accordingly.

The service selection module 44 allows for the selection of inter-operation with either the VDL/4 or ACARS network. The communications processor controls the ACARS MU interface 42 and determines the source of RX audio provided to the ACARS MU 46. TX audio, from the ACARS MU 46, is fanned out to the ACARS MSK modem 43 and to the ARINC 716 VHF AM R/T 49. An antenna switch is also provided so that a single VHF antenna can be shared between the ARINC 716 AM VHF radio 49 and the VDL/4 GFSK VHF radio 50. Control of the push-to-talk (PTT) signal to the VHF AM radio 49 is also provided to ensure that the transmitter is not active when it is not connected to the VHF antenna. Selection of either the VDL/4 network or an ACARS network can be controlled by the communications processor 45 based on navigation information, VDL/4 network management policy, and receipt of VDL/4 ground uplinks. This provides an automatic selection capability that is transparent to the pilot, based on pre-set decision rules.

The signal “Voice/Data Select” is also monitored by the communications processor 45 to determine if the ARINC 716 R/T is being used for voice communications. When this signal indicates that the ARINC 716 R/T 49 is being used for voice communications, the VHF antenna is switched to the ARINC 716 R/T. Voice use of the ARINC 716 R/T could indicate an emergency condition, and therefore takes precedence over all other uses of the VHF antenna and preempts both ACARS network use and VDL/4 network use of the VHF antenna.

The communications processor 45 provides the host for the software that implements VDL Mode 4 TCP/IP protocol functions, mimics the operation of the ACARS network, and provides the interface between these two network protocols. The data loader interface 51 allows for software updates and configuration file changes without removal of the unit from the aircraft. The communications processor 45 also provides the capability of updating the GFSK modem 52 software via the data loader interface. The ability to update modem and communications processor software and configuration files via the RF using FTP protocol may also be provided.

While various preferred embodiments of the present invention have been set forth above, those skilled in the art who have reviewed the present disclosure will readily appreciate that other embodiments can be realized within the scope of the invention. For example, communication protocols other than those disclosed can be used. Therefore, the present invention should be construed as limited only by the appended claims.

We claim:

1. A hybrid radio apparatus for a mobile radio station capable of operating in at least two different radio networks simultaneously, employing at least two different protocols, the hybrid radio apparatus comprising:
a hybridization module for at least a first one of the networks; and
radio equipment for at least a second one of the networks;
said hybridization module comprising electronics and software necessary to emulate some or all protocols of the first network, and communicating at a peer level with protocols of the second network resident in the hybrid radio apparatus, said emulation and peer level communication allowing an appearance of communication via network A.

2. The hybrid radio apparatus of claim 1, wherein the hybridization module is tailored to a set of network protocols which contains at least one member selected from the group consisting of ACARS, VDL/2, and VDL/4.

3. The hybrid radio apparatus of claim 1, wherein the radio equipment is designed to operate with a set of systems which contains at least one member selected from the group consisting of ACARS, VDL/2, and VDL/4.

4. The hybrid radio apparatus of claim 1, wherein the hybridization module operates for ACARS and the radio equipment operates for a VDL/4 network.

5. The hybrid radio apparatus of claim 1, wherein the hybrid radio apparatus automatically decides to operate via the first network or the second network, when both the first network and the second network are available, based on pre-set or user-specified decision criteria.

6. A hybrid radio apparatus for a mobile station, the hybrid radio apparatus comprising:
a hybridization module which emulates protocols normally in one or several ground facilities providing services for a first network or system;
mobile radio equipment operating on a second network or system which is different from the first network or system; and
mobile equipment usable with the second network or system over the mobile radio equipment and over the first network or system over the hybridization module.

7. The hybrid radio apparatus of claim 6, wherein the mobile equipment comprises a human interface and management unit.
